(19) United States
(12) Patent Application Publication
(10) Pub. No.: US 2021/0094213 A1
(43) Pub. Date: Apr. 1, 2021

(54) CONTROL DEVICE AND CONTROL METHOD FOR INJECTION MOLDING MACHINE

(71) Applicant: FANUC CORPORATION, Minamitsuru-gun (JP)

(72) Inventors: Atsushi HORIUCHI, Minamitsuru-gun (JP); Hiroyasu ASAOKA, Minamitsuru-gun (JP); Kenjirou Shimizu, Minamitsuru-gun (JP)

(21) Appl. No.: 17/036,127

(22) Filed: Sep. 29, 2020

(30) Foreign Application Priority Data
Sep. 30, 2019 (JP) 2019-179234

(51) Int. Cl. B29C 45/77; B29C 45/62; B29C 45/60; B29C 45/50; B29C 45/46; B29C 45/20; B29C 45/80

(52) U.S. Cl. CPC B29C 45/77; B29C 45/62; B29C 45/60; B29C 45/80; B29C 45/461; B29C 45/20; B29C 45/5008

(57) ABSTRACT

A control device for an injection molding machine is equipped with a pressure acquisition unit configured to acquire a resin pressure, a pressure reduction control unit configured to, after the screw has reached a predetermined metering position, reduce the resin pressure to a target pressure by performing at least one of reverse rotation and sucking back of the screw, and a standby pressure control unit configured to, after the resin pressure has reached the target pressure, keep the resin pressure within a predetermined range by causing the screw to be rotated in a state in which a position of the screw in an axial direction of the cylinder is maintained.

### CROSS-REFERENCE TO RELATED APPLICATION

This application is based upon and claims the benefit of priority from Japanese Patent Application No. 2019-179234 filed on Sep. 30, 2019, the contents of which are incorporated herein by reference.

### BACKGROUND OF THE INVENTION

### Field of the Invention

The present invention relates to a control device and a control method for an injection molding machine.

### Description of the Related Art

In the field of injection molding machines, a technique is known for preventing a molding failure in which a resin leaks from a cylinder, by reducing the pressure of the resin after the resin has been melted inside the cylinder. Such a technique is disclosed, for example, in Japanese Laid-Open Patent Publication No. 2008-230164. Such molding failures in which the resin leaks from the cylinder are also referred to as drooling or leakage.

According to the disclosed technique, the injection molding machine performs sucking back in a pressure reducing step (sucking back step) following a metering step in which the resin is melted. Consequently, the resin pressure arrives at a set pressure (target pressure) which is capable of preventing drooling.

### SUMMARY OF THE INVENTION

The resin, which has been metered and reduced in pressure, is injected after waiting for a mold to be prepared and made ready for use. The process of waiting until the mold is made ready for use after the reduction in pressure is also referred to as a standby step. During such a standby step, it is necessary for the resin pressure to be continuously adjusted until injection is performed. This is because the pressure of the melted resin fluctuates and the pressure fluctuation leads to the occurrence of drooling.

At this time, it is undesirable to perform sucking back multiple times during the standby step in order to adjust the resin pressure. This is because when sucking back is performed, there is a concern that air may be drawn into the cylinder. Air that is drawn into the cylinder becomes mixed with the resin and forms air bubbles therein, which causes molding defects.

Thus, the present invention has the object of providing a control device and a method of controlling an injection molding machine, in which the occurrence of molding defects during a standby step are prevented.

A first aspect of the present invention is a control device for an injection molding machine, the injection molding machine including a cylinder into which a resin is supplied, and a screw configured to move forward and rearward and rotate inside the cylinder, the injection molding machine being configured to perform metering of the resin while the resin is being melted inside the cylinder, by causing the screw to be moved rearward to a predetermined metering position while being forwardly rotated, the control device including a pressure acquisition unit configured to acquire a pressure of the resin, a pressure reduction control unit configured to, after the screw has reached the predetermined metering position, reduce the pressure of the resin to a predetermined target pressure by performing at least one of reverse rotation and sucking back of the screw, and a standby pressure control unit configured to, after the pressure of the resin has reached the target pressure, keep the pressure of the resin within a predetermined range by causing the screw to be rotated in a state in which a position of the screw in an axial direction of the cylinder is maintained.

Another aspect of the present invention is a method of controlling an injection molding machine, the injection molding machine including a cylinder into which a resin is supplied, and a screw configured to move forward and rearward and rotate inside the cylinder, the injection molding machine being configured to perform metering of the resin while the resin is being melted inside the cylinder, by causing the screw to be moved rearward to a predetermined metering position while being forwardly rotated, the method including a pressure reducing step of, after the screw has reached the predetermined metering position, reducing a pressure of the resin to a predetermined target pressure, by performing at least one of reverse rotation and sucking back of the screw while acquiring the pressure of the resin, and a standby pressure control step of, after the pressure reducing step, keeping the pressure of the resin within a predetermined range by causing the screw to be rotated in a state in which a position of the screw in an axial direction of the cylinder is maintained.

According to the present invention, the control device and the method of controlling an injection molding machine are provided in which the occurrence of molding defects during the standby step are prevented.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a side view of an injection molding machine according to an embodiment of the present invention;

FIG. 2 is a schematic cross-sectional view of an injection unit according to the embodiment;

FIG. 3 is a time chart of a molding cycle executed by the injection molding machine;

FIG. 4 is a schematic configuration diagram of a control device according to the embodiment;

FIG. 5 is a flowchart showing an example of a method of controlling the injection molding machine, which is executed by a control device of the embodiment;

FIG. 6 is a time chart of a resin pressure (applied to a resin inside a cylinder), a rotational speed (of a screw), a forward and rearward movement speed and a propulsive force (of the screw), in the case that the control method of FIG. 5 is performed; and

FIG. 7 is a schematic configuration diagram of the control device according to a first modification.

### DESCRIPTION OF THE PREFERRED EMBODIMENTS

Preferred embodiments of a control device and a control method for an injection molding machine according to the present invention will be presented and described in detail below with reference to the accompanying drawings. Moreover, it should be noted that the respective directions described below conform to the arrows shown in each of the drawings.

### Embodiments

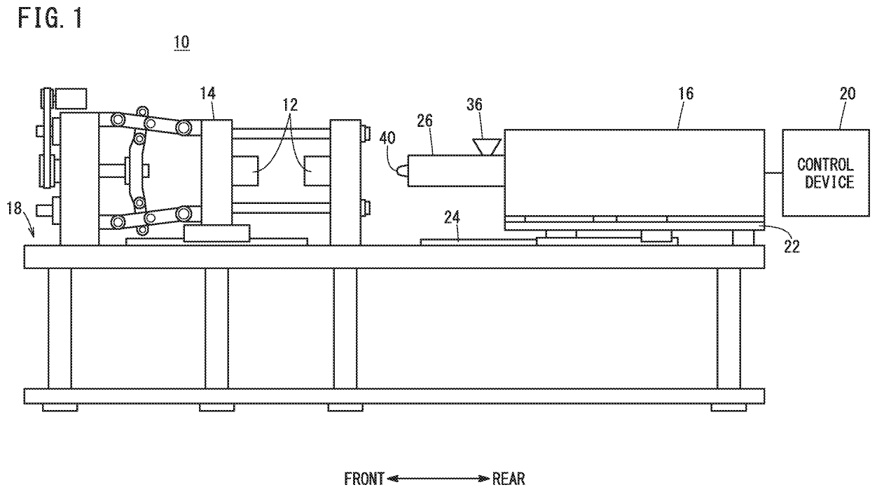

FIG. 1 is a side view of an injection molding machine 10 according to an embodiment of the present invention.

The injection molding machine 10 according to the present embodiment comprises a mold clamping unit 14 having a mold 12 that is capable of being opened and closed, an injection unit 16 that faces toward the mold clamping unit 14 in a front-rear direction, a machine base 18 on which such components are supported, and a control device 20 that controls the injection unit 16.

Among such components, the mold clamping unit 14 and the machine base 18 can be configured based on a known technique. Accordingly, in the following discussion, descriptions of the mold clamping unit 14 and the machine base 18 will be appropriately omitted.

Prior to describing the control device 20 of the present embodiment, at first, a description will be given concerning the injection unit 16, which is a control target of the control device 20.

The injection unit 16 is supported by a base 22, and the base 22 is supported by a guide rail 24 which is installed on the machine base 18 so that the base 22 is capable of moving forward and rearward. Consequently, the injection unit 16 is capable of moving forward and rearward on the machine base 18, and can both come into contact with and separate away from the mold clamping unit 14.

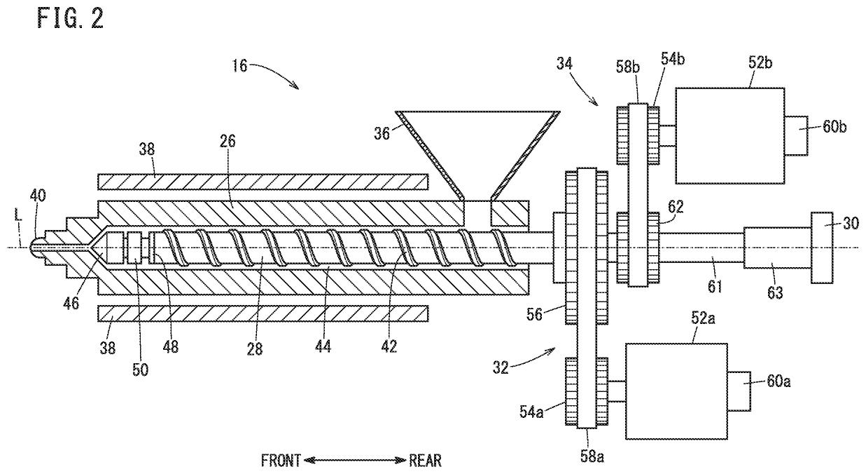

FIG. 2 is a schematic cross-sectional view of the injection unit 16.

The injection unit 16 is equipped with a tubular shaped heating cylinder (cylinder) 26, a screw 28 provided inside the cylinder 26, a pressure sensor 30 provided on the screw 28, and a first drive device 32 and a second drive device 34 connected to the screw 28.

The axial lines of the cylinder 26 and the screw 28 coincide with each other on an imaginary line L according to the present embodiment. Such a system may be referred to as an “in-line (in-line screw) system”. Further, the injection molding machine to which the in-line system is applied is also referred to as an “in-line injection molding machine”.

As advantages of such an in-line injection molding machine, there may be cited, for example, a point in which the structure of the injection unit 16 is simpler, and a point in which the maintainability thereof is excellent, as compared with other types of injection molding machines. In this instance, as another type of injection molding machine, for example, a preplasticating type injection molding machine is known.

As shown in FIG. 2, the cylinder 26 includes a hopper 36 provided on a rearward side, a heater 38 for heating the cylinder 26, and a nozzle 40 provided on a frontward side end thereof. Among such elements, the hopper 36 is provided with a supply port for supplying a molding material resin to the cylinder 26. Further, an injection port for injecting the resin into the cylinder 26 is provided on the nozzle 40.

The screw 28 includes a spiral flight part 42 provided to span across the longitudinal (front-rear) direction thereof. The flight part 42, together with an inner wall of the cylinder 26, constitutes a spiral flow path 44. The spiral flow path 44 guides in a frontward direction the resin that is supplied from the hopper 36 into the cylinder 26.

The screw 28 includes a screw head 46 which is on a distal end on the frontward side, a check seat 48 that is disposed at a certain distance in a rearward direction from the screw head 46, and a check ring (a ring for backflow-prevention) 50 that is capable of moving between the screw head 46 and the check seat 48.

The check ring 50 moves in the frontward direction relative to the screw 28 when the check ring receives a forward pressure from the resin located on a rearward side of the check ring 50 itself. Further, upon receiving a rearward pressure from the resin on the frontward side thereof, the check ring 50 moves in the rearward direction relative to the screw 28.

At a time of metering (to be described later), the resin which is supplied from the hopper 36 to the supply port of the cylinder 26 is fed and compressed in the frontward direction while being melted along the flow path 44 by the forward rotation of the screw 28, and the pressure on a more rearward side than the check ring 50 becomes larger. When this occurs, the check ring 50 moves in the frontward direction, and the flow path 44 is gradually opened accompanying such movement. Consequently, the resin becomes capable of flowing toward the frontward side beyond the check seat 48 along the flow path 44.

Conversely, at the time of injection, the pressure on the frontward side becomes greater than the pressure on the rearward side of the check ring 50. When this occurs, the check ring 50 moves in the rearward direction relative to the screw 28, and the flow path 44 is gradually closed accompanying such movement. When the check ring 50 is moved rearward until being seated on the check seat 48, a state is brought about in which it is maximally difficult for the resin to flow forward and rearward of the check ring 50, and a situation is prevented in which the resin on a more frontward side than the check seat 48 flows in reverse to the more rearward side than the check seat 48.

The pressure sensor 30, such as a load cell or the like for sequentially detecting the pressure imposed on the resin inside the cylinder 26, is attached to the screw 28. According to the present embodiment, the above-described “pressure imposed on the resin inside the cylinder 26” may also be referred to simply as a “resin pressure (pressure of a resin)”.

The first drive device 32 serves to rotate the screw 28 inside the cylinder 26. The first drive device 32 includes a servomotor 52a, a drive pulley 54a, a driven pulley 56, and a belt member 58a. The drive pulley 54a rotates integrally with a rotary shaft of the servomotor 52a. The driven pulley 56 is disposed integrally on the screw 28. The belt member 58a transmits the rotational force of the servomotor 52a from the drive pulley 54a to the driven pulley 56.

When the rotary shaft of the servomotor 52a rotates, the rotational force of the servomotor 52a is transmitted to the screw 28 via the drive pulley 54a, the belt member 58a, and the driven pulley 56. Consequently, the screw 28 rotates.

In this manner, by causing the rotary shaft of the servomotor 52a to rotate, the first drive device 32 serves to rotate the screw 28. Moreover, by changing the direction in which the rotary shaft of the servomotor 52a is rotated, in response to the changing, the direction of rotation of the screw 28 can be switched between forward rotation and reverse rotation.

A position/speed sensor 60a is provided on the servomotor 52a. The position/speed sensor 60a detects the rotational position and the rotational speed of the rotary shaft of the servomotor 52a. The detection result therefrom is output to the control device 20. Consequently, the control device 20 is capable of calculating the amount of rotation (angle of rotation), the rotational acceleration, and the rotational speed of the screw 28, based on the rotational position and the rotational speed detected by the position/speed sensor 60a. Further, the control device 20 can calculate the rotational force (rotational torque) of the screw 28 based on the current that drives the servomotor 52a.

The second drive device 34 serves to move the screw 28 forward and rearward inside the cylinder 26. The second drive device 34 includes a servomotor 52b, a drive pulley 54b, a belt member 58b, a ball screw 61, a driven pulley 62, and a nut 63. The drive pulley 54b rotates integrally with a rotary shaft of the servomotor 52b. The belt member 58b transmits the rotational force of the servomotor 52b from the drive pulley 54b to the driven pulley 62. An axial line of the ball screw 61 and an axial line of the screw 28 coincide with each other on the imaginary line L. The nut 63 is screw-engaged with the ball screw 61.

When a rotational force is transmitted from the belt member 58b, the ball screw 61 converts the rotational force into linear motion, and transmits the linear motion to the screw 28. Consequently, the screw 28 is moved forward and rearward.

In this manner, by causing the rotary shaft of the servomotor 52b to rotate, the second drive device 34 serves to move the screw 28 forward and rearward. Moreover, by changing the direction in which the rotary shaft of the servomotor 52b is rotated, in response to the changing, the movement direction of the screw 28 can be switched between forward movement (advancing) and rearward movement (retracting).

Further, a position/speed sensor 60b is provided on the servomotor 52b. The position/speed sensor 60b detects the rotational position and the rotational speed of the rotary shaft of the servomotor 52b. As the position/speed sensor 60b, there may be used the same type of sensor as the position/speed sensor 60a described above, however the present invention is not limited to this feature. Consequently, the control device 20 is capable of calculating the forward position and the rearward position of the screw 28 in the front-rear direction, as well as the forward and rearward movement speeds of the screw 28, based on the rotational position and the rotational speed detected by the position/speed sensor 60b. Further, the control device 20 can calculate a propulsive force of the screw 28 in the front-rear direction, based on the current that drives the servomotor 52b.

In the above-described injection unit 16, by the screw 28 being forwardly rotated while introducing the resin into the cylinder 26 through the hopper 36, the introduced resin is gradually fed and compressed in the frontward direction while moving along the flow path 44. During such a time, the resin is melted (plasticized) by being subjected to heating by the heater 38 and due to the rotational force of the screw 28. The molten resin accumulates in a region on the frontward side of the check seat 48 inside the cylinder 26. Hereinafter, the region on the frontward side of the check seat 48 inside the cylinder 26 is also referred to as a “metering region”.

The forward rotation of the screw 28 is performed during a period from a state in which the screw 28 has fully advanced inside the cylinder 26 (a state in which the volume of the metering region is at a minimum), and until the screw 28 moves rearward to a predetermined metering position. Further, the rearward movement of the screw 28 is performed so as to maintain the resin pressure in the vicinity of a predetermined value (metering pressure) P1. This series of steps is also referred to as a “metering (metering step)”. By setting the resin pressure during metering in close proximity to the metering pressure P1, and determining the rearward movement distance of the screw 28 to the metering position, it is possible to keep the volume of the metering region and the density of the resin substantially constant each time that the metering is performed.

After the screw 28 has reached the metering position, the injection unit 16 reduces the resin pressure by reverse rotation or sucking back of the screw 28. Such a process may be referred to as a “reduction in pressure (pressure reducing step)”. The reverse rotation of the screw 28 is an operation of causing the screw 28 to rotate in a direction opposite to that at the time of metering. Consequently, the resin on the more rearward side than the check seat 48 is scraped toward the rearward side inside the cylinder 26 along the flow path 44. Upon doing so, the density of the resin on the more rearward side than the check seat 48 decreases, and therefore, the resin pressure inside the cylinder 26 decreases. Sucking back is an operation of causing the screw 28 to be moved rearward from the metering position. Consequently, the volume of the metering region increases. Upon doing so, the density of the resin in the metering region decreases, and therefore, the resin pressure decreases.

In this manner, both of reverse rotation and sucking back of the screw 28 are an operation that enables the resin pressure to be reduced. In the pressure reducing step, only one of reverse rotation and sucking back of the screw 28 may be performed, or both of them may be performed.

The pressure reducing step is preferably continued until the resin pressure becomes the target pressure P0. The target pressure P0 is a pressure that is smaller than the metering pressure P1, and according to the present embodiment, is zero. However, the target pressure P0 is not necessarily limited to zero. The target pressure P0, for example, may be a value in close proximity to zero. By reducing the resin pressure from the metering pressure P1 to the target pressure P0, the occurrence of drooling can be suppressed.

After the pressure reducing step, and following a waiting period (standby step), the injection unit 16 executes injection (an injection step). The standby step is a process in which the injection unit 16 waits after completion of the pressure reducing step, and until a state of being ready to start the injection step is brought about by closing the mold 12 in a later-described mold closing step. The injection step is a process of injecting the resin, which is accumulated in the metering region inside the cylinder 26, into a cavity inside the mold 12. In the injection step, the screw 28 is advanced on the side of the injection unit 16 while a mold clamping force is applied to the closed mold 12 on the side of the mold clamping unit 14. At this time, the mold 12 and the nozzle 40 are pressed into contact (placed in a nozzle touching). As a result, the molten resin is injected from the tip end of the nozzle 40 into the cavity inside the mold 12.

After the injection step, in the mold clamping unit 14, “cooling (a cooling step)”, “mold opening (a mold opening step)”, “ejecting (an ejecting step)”, “removal (a removal step)” and “mold closing (a mold closing step)” are performed. The cooling step is a step of cooling and solidifying the resin that is filled in the cavity of the mold 12. The mold opening step is a step of opening the mold 12. The ejecting step is a step of ejecting the molded product from the mold 12 in an open state by a non-illustrated ejecting pin (ejector) provided in the mold 12. The removal step is a step of removing (taking out) the ejected molded product. The mold closing step is a step of closing the mold 12. In accordance therewith, the mold 12 is placed in a state in which it can be filled again with the resin.

The combination of the plurality of steps executed by the injection molding machine 10 in order to produce the molded product is also referred to as a “molding cycle”. The metering step, the pressure reducing step, the standby step, the injection step, the cooling step, the mold opening step, the ejecting step, the removal step, and the mold closing step are typical steps that can be included in the molding cycle. By repeatedly executing the molding cycle, the injection molding machine 10 is capable of mass-producing molded products.

The injection molding machine 10 can divide the plurality of steps included in the molding cycle into steps executed on the side of the injection unit 16, and steps executed on the side of the mold clamping unit 14, and perform such steps in parallel. Consequently, the injection molding machine 10 is capable of shortening the time period (cycle time) T required for one molding cycle to be completed, and the molded products can be manufactured efficiently.

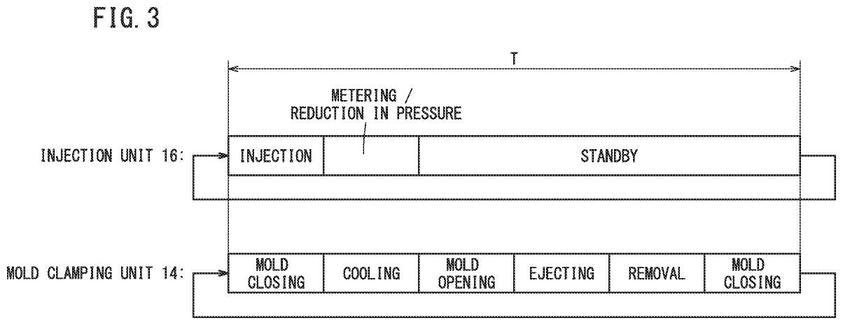

FIG. 3 is a time chart of the molding cycle executed by the injection molding machine 10. In FIG. 3, the horizontal axis represents time.

In the example shown in FIG. 3, the injection unit 16 completes the metering step and the pressure reducing step while the cooling step is being carried out on the side of the mold clamping unit 14. In addition, the injection unit 16 continues the standby step until a state of being ready to start the injection step is brought about while the mold closing step is being carried out on the side of the mold clamping unit 14. Consequently, after completion of the mold closing step, the injection unit 16 can quickly execute the injection step.

It should be noted that the time periods required for the respective steps shown in FIG. 3 are merely examples. Concerning the time zone of the standby step, the length of such a time period varies depending on where within the time zone from the cooling step to the removal step the pressure reducing step is completed, and therefore, the time zone of the standby step may or may not overlap with the time zone from the cooling step to the removal step.

In this instance, points that should be considered in order to perform high quality molding will be described. In the molding cycle in which the standby step is included, when forward and rearward movements and rotation of the screw 28 are stopped in the standby step, the resin pressure deviates from the target pressure P0 during the standby step. The reason for such a deviation is because the resin obtains both viscosity and fluidity due to being melted and being fed and compressed in the metering step and the pressure reducing step.

The pressure of the resin, which has obtained such a viscosity and fluidity, deviates from the target pressure P0 in the manner described below. More specifically, the state of the resin immediately after the start of the standby step is significantly influenced by the control performed under the reduced pressure. For example, in the pressure reducing step, the reverse rotation and sucking back are performed as has already been described above. Due to the reverse rotation and sucking back, a situation may occur in which the direction of the flow of the resin inside the cylinder 26, which was in a direction from the rearward direction to the frontward direction during metering, is reversed. Such a situation is also referred to as resin backflow. Even after the pressure reducing step, that is, even after the standby step has started, such backflow does not stop immediately, and is more likely to continue as the amount of the reduction in pressure (the amount of rotation, the retracted position (rearward-moved position)) is excessive, or as the vigorousness (rapidity) of the reduction in pressure (the rotational speed, the rearward movement speed) is excessive. When this happens, the amount of resin accumulated in the metering region in the standby step is reduced. As a result, the resin pressure becomes lower than the target pressure P0.

On the other hand, if the amount of the reduction in pressure is excessively small, or the vigorousness of the reduction in pressure is excessively small, the reverse flow of the resin cannot be made to occur in a sufficient manner. The reason therefor is that a state is maintained in which the pressure on the rearward side of the check seat 48 is higher than the pressure on the frontward side of the check seat 48, and the flow of the resin from the rearward side of the check seat 48 to the metering region on the frontward side, which has occurred in the metering step, continues. In this case, the amount of resin in the metering region increases in the standby step. As a result, the resin pressure after having completed the pressure reducing step becomes higher than the target pressure P0.

In addition to the above, in the event there is a pressure difference between the frontward side (the metering region) and the rearward side of the check seat 48, the resin inside the cylinder 26 flows in a manner so as to reduce the pressure difference. At this time, in a state in which the check ring 50 does not close the flow path 44, the resin inside the cylinder 26 flows between the frontward side and the rearward side of the check seat 48. As a result, although the aforementioned pressure difference is eliminated, the resin pressure disadvantageously deviates from the target pressure P0.

As the resin pressure becomes higher than the target pressure P0, the greater the concern becomes that drooling will occur. Further, as the resin pressure becomes lower than the target pressure P0, the greater the concern becomes that air will be drawn into the cylinder 26 from the nozzle 40, and that air bubbles will become mixed in the resin inside the cylinder 26. Drooling not only causes variations in the masses of the molded products and causes a deterioration in the quality thereof as manufactured products, but also causes cold slag to be generated which leads to clogging of the nozzle 40. Further, variations in the amount of resin accumulated in the metering region also become a cause of variations in the masses of the molded products. Such a variation in the masses of the molded products leads to poor appearance and poor quality of the molded products. Therefore, from the standpoint of performing high-quality molding, it is desirable to appropriately adjust the resin pressure not only in the metering step and the pressure reducing step, but also during the standby step.

Taking into consideration the aforementioned points, the control device 20 according to the present embodiment controls the injection unit 16, whereby the standby step is suitably executed. Hereinafter, a description will be given concerning the configuration of the control device 20.

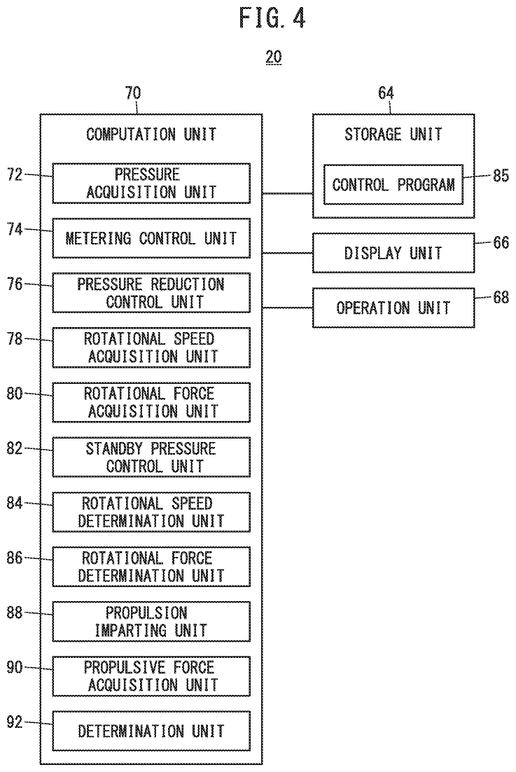

FIG. 4 is a schematic configuration diagram of the control device 20.

As illustrated in FIG. 4, the control device 20 is equipped with a storage unit 64, a display unit 66, an operation unit 68, and a computation unit 70 as a hardware configuration. The computation unit 70 may be configured by a processor such as a CPU (Central Processing Unit) or the like, however the present invention is not limited to this feature. The storage unit 64 includes a volatile memory and a nonvolatile memory, neither of which are shown. Examples of the volatile memory include a RAM or the like. Examples of the nonvolatile memory include a ROM, a flash memory, or the like.

A predetermined control program 85 for controlling the injection unit 16 is stored in advance in the storage unit 64, and apart therefrom, information is stored in the storage unit 64 as needed during execution of the control program 85.

The display unit 66, although not particularly limited, is a display device including, for example, a liquid crystal screen, and appropriately displays information in relation to the control process performed by the control device 20.

The operation unit 68, although not particularly limited, includes, for example, a keyboard, a mouse, or a touch panel that is attached to the screen of the display unit 66, and is used by an operator in order to transmit commands to the control device 20.

As illustrated in FIG. 4, the computation unit 70 includes a pressure acquisition unit 72, a metering control unit 74, a pressure reduction control unit 76, a rotational speed acquisition unit 78, and a rotational force acquisition unit 80. These units are realized by the computation unit 70 executing the aforementioned control program 85 in cooperation with the storage unit 64.

The pressure acquisition unit 72 sequentially acquires the resin pressure detected by the pressure sensor 30. The acquired resin pressure is stored in the storage unit 64. At this time, the acquired resin pressure is stored in the storage unit 64, for example, in the form of time series data.

The metering control unit 74 executes the metering step, by controlling the injection unit 16 while appropriately referring to the resin pressure acquired by the pressure acquisition unit 72. More specifically, by controlling the first drive device 32 and the second drive device 34, the metering control unit 74 moves the screw 28 rearward to the metering position while forwardly rotating the screw 28.

At this time, the metering control unit 74 controls the first drive device 32 and the second drive device 34 on the basis of predetermined metering conditions (hereinafter, also simply referred to as “metering conditions”), in a manner so that the resin pressure is maintained in close proximity to the metering pressure P1. A forward rotational speed (metering rotational speed) Vr of the screw 28 during metering, and the metering pressure P1 are defined as such metering conditions. The metering control unit 74 may refer to the metering conditions that are stored in advance in the storage unit 64, or may follow along with metering conditions that are instructed (specified) by the operator via the operation unit 68.

The pressure reduction control unit 76 controls the injection unit 16 and executes the pressure reducing step. More specifically, the pressure reduction control unit 76 reduces the resin pressure to the target pressure P0, by carrying out at least one of reverse rotation and sucking back of the screw 28, after the screw 28 has reached the metering position. As an example, the pressure reduction control unit 76 according to the present embodiment performs both reverse rotation and sucking back of the screw 28 sequentially in this order.

In the case that reverse rotation of the screw 28 is carried out, the pressure reduction control unit 76 can reversely rotate the screw 28 on the basis of predetermined reverse rotation conditions (hereinafter, also simply referred to as “reverse rotation conditions”). The reverse rotation conditions are indicative of conditions related to reverse rotation of the screw 28. Items that can be specified as the reverse rotation conditions, although not limited thereto, for example, are a duration of the reverse rotation, the maximum amount of the reverse rotation, a speed of the reverse rotation, and an acceleration of the reverse rotation. The reverse rotation conditions may be designated (specified) in advance by the operator, or may be automatically determined by the control device 20.

Further, in the case that sucking back is performed, the pressure reduction control unit 76 can perform sucking back based on predetermined suck back conditions (hereinafter, also simply referred to as “suck back conditions”). The suck back conditions are indicative of conditions related to sucking back of the screw 28. Items that can be specified in the suck back conditions, although not limited thereto, for example, are a duration of sucking back, the amount of sucking back (rearward movement distance), and a rearward movement speed when sucking back is performed. The suck back conditions may be designated (specified) in advance by the operator, or may be automatically determined by the control device 20.

The rotational speed acquisition unit 78 acquires the rotational speed of the screw 28. The rotational speed of the screw 28 can be acquired based on the rotational speed of the rotary shaft of the servomotor 52a as detected by the position/speed sensor 60a.

The acquired rotational speed of the screw 28 is stored in the storage unit 64. The storage format at this time, although not necessarily limited thereto, for example, is a time series data format. Consequently, the computation unit 70 can appropriately refer to the rotational speed of the screw 28 that is stored in the storage unit 64.

The rotational force acquisition unit 80 acquires the rotational force (rotational torque) of the screw 28. The rotational force of the screw 28 can be acquired as a value obtained based on the current that drives the servomotor 52a.

The acquired rotational force of the screw 28 is stored in the storage unit 64. The storage format at this time, although not necessarily limited thereto, for example, is a time series data format. Consequently, the computation unit 70 can appropriately refer to the rotational force of the screw 28 that is stored in the storage unit 64.

The computation unit 70 further includes a standby pressure control unit 82, a rotational speed determination unit 84, a rotational force determination unit 86, a propulsion imparting unit 88, a propulsive force acquisition unit 90, and a determination unit 92. These units, similar to the pressure reduction control unit 76 and the like, are realized by the computation unit 70 executing the aforementioned control program 85 in cooperation with the storage unit 64.

The standby pressure control unit 82 adjusts the resin pressure during the standby step. More specifically, the standby pressure control unit 82 keeps the resin pressure within a predetermined range by causing the screw 28 to be rotated in a state in which the position of the screw 28 in an axial direction (front-rear direction) of the cylinder 26 is maintained, in a period from when the resin pressure has reached the target pressure P0 until when the injection step is executed.

The predetermined range is a range around the vicinity of the target pressure P0 and includes the target pressure P0 therein. Accordingly, the standby pressure control unit 82 can control the rotation of the screw 28 in a manner so that the resin pressure is maintained in close proximity to the target pressure P0 during the standby step.

The rotation of the screw 28 which is controlled by the standby pressure control unit 82 may include both forward rotation and reverse rotation. More specifically, when the resin pressure is higher than the predetermined range, the standby pressure control unit 82 can reduce the resin pressure by reversely rotating the screw 28. Further, when the resin pressure is lower than the predetermined range, the standby pressure control unit 82 can increase the resin pressure by forwardly rotating the screw 28.

The standby pressure control unit 82 causes the screw 28 to rotate in a state in which the position of the screw 28 in the front-rear direction is maintained. More specifically, sucking back is not included in the means for adjusting the resin pressure that can be executed by the standby pressure control unit 82. If sucking back is performed several times, the concern that air will be drawn into the cylinder 26 through the nozzle 40 becomes greater. This becomes a cause of air bubbles (foreign material) being mixed in the resin. Since the standby pressure control unit 82 adjusts the resin pressure not by sucking back but by rotating the screw 28, it is possible to satisfactorily prevent the air from being drawn into the cylinder 26. Moreover, maintenance of the position of the screw 28 in the front-rear direction can be realized by the standby pressure control unit 82 invoking operation of the propulsion imparting unit 88. A description will be given later concerning the propulsion imparting unit 88.

The rotational speed determination unit 84 determines an upper limit speed on the basis of the maximum value of the rotational speed of the screw 28 acquired while the pressure reduction control unit 76 reversely rotates the screw 28. The maximum value of the rotational speed of the screw 28 while the pressure reduction control unit 76 is rotating the screw 28 in the reverse direction can be acquired by the rotational speed acquisition unit 78. The rotational speed determination unit 84 may set the maximum value as the upper limit speed, or may compensate the maximum value to thereby set as the upper limit speed a value that is less than or equal to the maximum value. The upper limit speed determined by the rotational speed determination unit 84 is stored in the storage unit 64, and can be appropriately referred to by the standby pressure control unit 82 as one (a predetermined condition) of the rotation conditions when the screw 28 is rotated.

The rotational force determination unit 86 determines an upper limit rotational force on the basis of the maximum value of the rotational force of the screw 28 acquired while the pressure reduction control unit 76 reversely rotates the screw 28. The maximum value of the rotational force of the screw 28 while the pressure reduction control unit 76 is rotating the screw 28 in the reverse direction can be acquired by the rotational force acquisition unit 80. The rotational force determination unit 86 may set the maximum value as the upper limit rotational force, or may compensate the maximum value to thereby set as the upper limit rotational force a value that is less than or equal to the maximum value. The upper limit rotational force determined by the rotational force determination unit 86 is stored in the storage unit 64, and can be appropriately referred to by the standby pressure control unit 82 as one of the predetermined conditions when the screw 28 is rotated.

When the screw 28 is rotated, the standby pressure control unit 82 controls absolute values of the rotational speed and the rotational force so as not to exceed the absolute values of the upper limit speed and the upper limit rotational force. In accordance with this feature, it is possible to prevent the rotational speed and the rotational force of the screw 28, which are controlled by the standby pressure control unit 82, from becoming excessive.

Although the standby pressure control unit 82 may perform both a control of limiting the rotational speed of the screw 28 to a value that is less than or equal to the upper limit speed, and a control of limiting the rotational force of the screw 28 to a value that is less than or equal to the upper limit rotational force, only one of such controls may also be selected. Such a selection may be performed by the operator via the operation unit 68.

Such a selection can be based on the material properties of the resin. In particular, depending on the material, the resins can be classified into resins that flow easily and resins that flow with difficulty. As the resin flows more easily, it becomes easier for the rotational speed of the screw 28 to be raised when the screw 28 is rotated, and consequently a smaller rotational force suffices. Further, as the resin flows with greater difficulty, it becomes more difficult for the rotational speed to be raised when the screw 28 is rotated, and a larger rotational force is required. Accordingly, when an easily flowing resin is introduced into the cylinder 26, the rotational speed is limited based on the upper limit speed in a manner so that the rotational speed does not become too high, whereby it is possible to realize a fine adjustment of the resin pressure. Further, when a resin for which flowing is difficult is introduced into the cylinder 26, the rotational force is limited based on the upper limit rotational force in a manner so that the rotational force does not become too great, whereby it is possible to realize a fine adjustment of the resin pressure.

Operation of the propulsion imparting unit 88 is invoked by the standby pressure control unit 82. In the standby step, there is a concern that the position of the screw 28 in the front-rear direction inside the cylinder 26 may undergo shifting in position due to being pressed by the resin. After the resin pressure has reached the target pressure P0, the propulsion imparting unit 88 appropriately applies a propulsive force to the screw 28 in the front-rear direction to thereby maintain the position of the screw 28 in the axial direction of the cylinder 26. By controlling the second drive device 34, the propulsion imparting unit 88 imparts the propulsive force to the screw 28, and prevents positional shifting thereof.

The propulsive force acquisition unit 90 sequentially acquires the propulsive force imparted to the screw 28 by the propulsion imparting unit 88. The propulsive force can be acquired based on the current that drives the servomotor 52b.

The determination unit 92 determines whether or not the propulsive force acquired by the propulsive force acquisition unit 90 has exceeded a predetermined threshold value Th. The threshold value Th can be designated (specified) by the operator in advance and stored in the storage unit 64. In the case it is determined that the propulsive force has exceeded the threshold value Th, the determination unit 92 can invoke operation of the standby pressure control unit 82.

An exemplary configuration of the control device 20 has been described above. Next, a description will be given concerning a method of controlling the injection molding machine 10. Moreover, as a premise, it is assumed that the metering conditions have been specified in advance.

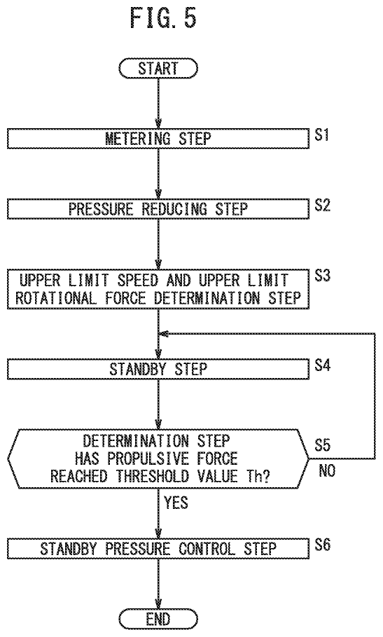

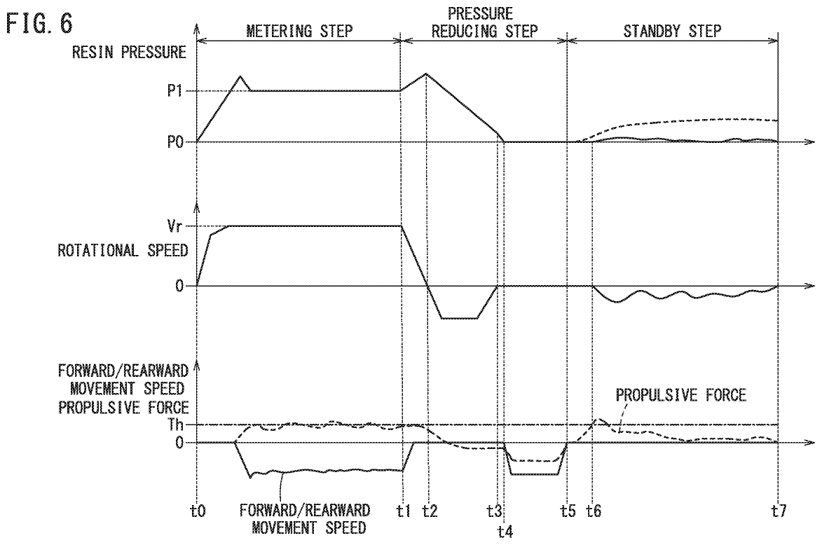

FIG. 5 is a flowchart showing an example of a control method for the injection molding machine 10 according to the present embodiment. FIG. 6 is a time chart of the resin pressure (applied to the resin inside the cylinder 26), the rotational speed (of the screw 28), and the forward and rearward movement speeds and the propulsive force (of the screw 28) in the case that the control method of FIG. 5 is performed.

Concerning FIG. 6, on the vertical axis, there are represented in this order from the top of the drawing the resin pressure, the rotational speed, the forward and rearward movement speed, and the propulsive force. Further, the horizontal axis in each of the time charts represents time.

Time t0 in FIG. 6 indicates a point in time when the metering step is started. Further, time t1 indicates a point in time at which the screw 28 arrives at the metering position. A time period from time t0 to time t1 is a time zone in which the metering step is carried out in the injection molding machine 10.

First, the control device 20 performs metering of the resin inside the cylinder 26 while melting the resin by moving the screw 28 rearward to the metering position, while causing the screw 28 to forwardly rotate (step S1: metering step). The metering step is carried out on the basis of the metering conditions. The metering step continues until time t1 when the screw 28 reaches the metering position.

As shown in FIG. 6, the rotational speed of the screw 28 starts increasing from the start of the metering step at time t0, and thereafter, reaches a predetermined metering rotational speed Vr specified by the metering conditions. In addition, from the time of reaching Vr until time t1, the rotational speed of the screw 28 is adjusted so as to maintain the metering rotational speed Vr.

Further, the resin pressure starts increasing after time t0 accompanying the forward rotation of the screw 28, and thereafter, reaches the predetermined metering pressure P1 specified by the metering conditions. The forward and rearward movement speed of the screw 28 starts to decrease from when the resin pressure comes in close proximity to the metering pressure P1 after the metering step has been started. This indicates that the screw 28 is being moved rearward. In addition, from the time of starting to decrease the speed until time t1, the forward and rearward movement speed of the screw 28 is controlled in a manner so that the resin pressure becomes the metering pressure P1.

Time t2 in FIG. 6 indicates a point in time when the reverse rotation of the screw 28 is started. Further, time t3 indicates a point in time when the reverse rotation of the screw 28 is ended. Time t4 indicates a point in time when sucking back is started. Time t5 indicates a point in time when sucking back is completed. A time period from time t1 to time t5 is a time zone in which the pressure reducing step is carried out in the injection molding machine 10.

When the screw 28 reaches the metering position, the control device 20 lowers the resin pressure to the target pressure P0 (step S2: pressure reducing step). The resin pressure can be lowered by performing at least one of reverse rotation and sucking back of the screw 28. As has already been described above, the control device 20 according to the present embodiment reduces the resin pressure by sequentially performing reverse rotation and sucking back of the screw 28 in this order. Moreover, the fact that the rotational speed of the screw 28 is less than zero from time t2 to time t3 indicates that the screw 28 is rotating in reverse.

During a period from time t2 to time t3, the rotational speed and the rotational force of the reverse rotation of the screw 28 are successively acquired. Based on the rotational speed and the rotational force acquired in the period from time t2 to time t3, the control device 20 determines the upper limit speed and the upper limit rotational force, prior to starting a later-described standby pressure control step (step S3: upper limit speed and upper limit rotational force determination step).

Time t6 in FIG. 6 is a point in time when the propulsive force has reached the threshold value Th. Time t7 is a point in time when the injection step is started. A time period from time t5 to time t7 is a time zone in which the standby step is carried out in the injection molding machine 10.

At a point in time not later than time t5 at which the reverse rotation and sucking back of the screw 28 are completed, the resin pressure reaches the target pressure P0. Thereafter, by invoking operation of the propulsion imparting unit 88, the control device 20 maintains the position of the screw 28 in the front-rear direction (step S4: standby step).

In the standby step, since rotation of the screw 28 is not carried out by the standby pressure control unit 82, and the position of the screw 28 in the front-rear direction is maintained, the resin pressure fluctuates accompanying the passage of time. After initiation of the standby step, the determination unit 92 determines whether or not the propulsive force has reached the threshold value Th (step S5: determination step). The propulsive force changes as the resin pressure changes. Accordingly, by determining whether or not the propulsive force has exceeded the threshold value Th, it is possible to determine whether or not the resin pressure has started to deviate from the target pressure P0.

In the case it is determined in the determination step that the propulsive force has reached the threshold value Th (YES), a standby pressure control step, to be described later, is initiated. In the case it is not determined that the propulsive force has reached the threshold value Th (NO), the process flow of the standby step and the determination step is performed again.

When the propulsive force reaches the threshold value Th, the standby pressure control unit 82 keeps the resin pressure within the predetermined range by causing the screw 28 to rotate (step S6: standby pressure control step). At this time, from initiation of the standby step, the position of the screw 28 in the front-rear direction of the cylinder 26 is continuously maintained.

The dashed line shown in the resin pressure section in FIG. 6 shows an example of a transition (temporal change) of the resin pressure for a case in which it is assumed that the standby pressure control unit 82 does nothing. As indicated by the dashed line, if left alone, the resin pressure deviates from the target pressure P0. Such a condition becomes a cause of drooling in the standby step.

In contrast thereto, according to the present embodiment, since the standby pressure control unit 82 causes the screw 28 to rotate, the transition of the resin pressure after time t6 becomes as shown by the solid line in FIG. 6. Unlike the transition shown by the dashed line, since the resin pressure is maintained in close proximity to the target pressure P0, the occurrence of drooling is prevented in the interval from time t5 to time t7. Further, since sucking back is not repeated in order to adjust the resin pressure, it is also possible to prevent air bubbles from being mixed in the resin.

The screw 28 in the interval from time t6 to time t7 rotates with a rotational speed that does not exceed an absolute value of the upper limit speed which is determined in advance. Further, the screw 28 rotates with a rotational force that does not exceed an absolute value of the upper limit rotational force which is determined in advance. Consequently, it is possible to prevent the rotational speed and the rotational force of the screw 28 from becoming excessive in the interval from t6 to t7, while at the same time, it is possible to prevent drooling and the mixing of air bubbles.

The standby pressure control step comes to an end together with initiation of the injection step (END). The start of the injection step can be determined, for example, by the standby pressure control unit 82 receiving a signal from the mold clamping unit 14 to the effect that the mold 12 has been closed in the mold closing step.

The above description is offered as one example of the control device 20 and the control method according to the present embodiment. In accordance with such a control device 20, any concern over the occurrence of molding defects such as drooling, cold slag, or the mixing of air bubbles is reduced. In the injection molding machine 10 which is equipped with the control device 20, immediately upon completion of the mold closing step on the side of the mold clamping unit 14, a transition is rapidly made from the standby step to the injection step on the side of the injection unit 16, whereby molded products of high quality can be efficiently produced.

Moreover, the device or apparatus to which the above-described control device 20 can be applied is not limited to an in-line injection molding machine (the injection molding machine 10). The control device 20 may be applied to a preplasticating type injection molding machine (a screw preplasticating type injection molding machine) which is equipped with a screw.

Further, the configurations of the first drive device 32 and the second drive device 34 are not limited to the configurations described above. For example, instead of the servomotor 52a and the servomotor 52b, at least one of the first drive device 32 and the second drive device 34 may include a hydraulic cylinder or a hydraulic motor.

### [Modifications]

Although an embodiment has been described above as one example of the present invention, it goes without saying that various modifications or improvements are capable of being added to the above-described embodiment. It is clear from the scope of the claims that other modes to which such modifications or improvements have been added can be included within the technical scope of the present invention.

### (Modification 1)

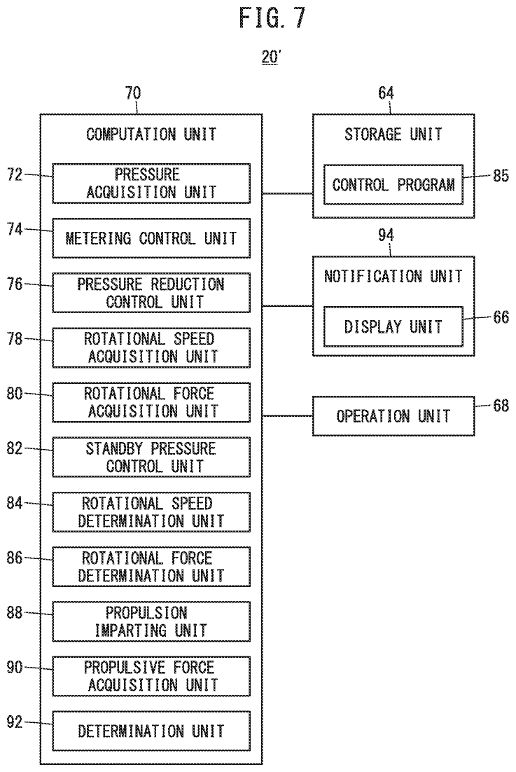

FIG. 7 is a schematic configuration diagram of the control device 20′ according to a first modification. The same elements as those in the embodiment are designated using the same reference numerals.

The control device 20′ may further be equipped with a notification unit 94. The notification unit 94, although not particularly limited to such features, includes, for example, a speaker that emits sound, and a lamp (notification lamp) that emits light. Further, as shown in FIG. 7, the notification unit 94 may also include the display unit 66 that was described in the embodiment.

The notification unit 94 issues a notification of the control state of the screw 28 when the standby pressure control unit 82 is causing the screw 28 to be rotated. For example, in the case of the notification unit 94 having the display unit 66, by displaying a predetermined icon (graphical information) or a message (character information) on the display unit 66, the standby pressure control unit 82 provides a notification to the operator as to whether or not the resin pressure is currently being adjusted.

### (Modification 2)

The standby pressure control unit 82 need not necessarily perform both forward rotation and reverse rotation of the screw 28. The standby pressure control unit 82 may be configured in a manner so as not to cause the screw 28 to be rotated when the resin pressure is less than a predetermined range, and to cause the screw 28 to be rotated in reverse when the resin pressure is greater than the predetermined range.

This is because, in the case that the resin pressure is less than the predetermined range (the target pressure P0), the concern that drooling may occur will not be so great even if left alone. Further, this is also because when the screw 28 is forwardly rotated, although the resin is fed and compressed in the frontward direction of the cylinder 26, at that time, there is a possibility that drooling may occur.

### (Modification 3)

At least one of the upper limit speed and the upper limit rotational force need not necessarily be determined. For example, from among the upper limit speed and the upper limit rotational force, the upper limit rotational force need not necessarily be determined.

In this case, the rotational speed determination unit 84 or the rotational force determination unit 86 may be appropriately omitted from the configuration of the control device 20. Consequently, the configuration of the control device 20, as well as the control method for the injection molding machine 10 can be simplified.

### (Modification 4)

When determining at least one of the upper limit speed and the upper limit rotational force, such values may be determined by the operator via the operation unit 68. In this case as well, the rotational speed determination unit 84 or the rotational force determination unit 86 may be appropriately omitted from the configuration of the control device 20.

### (Modification 5)

In the case that the metering can be executed by another device, the metering control unit 74 can be omitted from the configuration of the control device 20. In this case, the control device 20 may be started upon completion of the metering. Further, the control device 20 may include a constituent element for controlling the injection step within the molding cycle, or may include a constituent element for controlling the steps that are executed on the side of the mold clamping unit 14 within the molding cycle.

### (Modification 6)

The determination unit 92 may determine not whether or not the propulsive force has exceeded the threshold value Th, but whether or not the resin pressure has exceeded the predetermined threshold value Th′.

### (Modification 7)

The above-described embodiments and the modifications thereof may be appropriately combined within a range in which no technical inconsistencies occur.

### Inventions that can be Obtained from the Embodiment

The inventions that can be grasped from the above-described embodiment and the modifications thereof will be described below.

### <First Invention>

The control device (20) for the injection molding machine (10) is provided. The injection molding machine includes the cylinder (26) into which the resin is supplied, and the screw (28) that moves forward and rearward and rotates inside the cylinder (26). The injection molding machine performs metering of the resin while the resin is being melted inside the cylinder (26), by causing the screw (28) to be moved rearward to a predetermined metering position while being forwardly rotated. The control device includes the pressure acquisition unit (72) that acquires the resin pressure (the pressure of the resin), the pressure reduction control unit (76) configured to, after the screw (28) has reached the predetermined metering position, reduce the resin pressure to the predetermined target pressure by performing at least one of reverse rotation and sucking back of the screw (28), and the standby pressure control unit (82) configured to, after the resin pressure has reached the target pressure, keep the resin pressure within a predetermined range by causing the screw (28) to be rotated in a state in which a position of the screw (28) in the axial direction of the cylinder (26) is maintained.

In accordance with such features, the control device (20) for the injection molding machine (10) is provided in which the occurrence of molding defects during the standby step are prevented.

The injection molding machine (10) may further include the nozzle (40) that injects the resin that is melted inside the cylinder (26), and the standby pressure control unit (82) may keep the resin pressure within the predetermined range, during a period from when the resin pressure has reached the target pressure until when the resin is injected from the nozzle (40). In accordance with such features, drooling and the entry of air bubbles (foreign material) into the resin during the standby step are prevented.

The target pressure may be included within the predetermined range. In accordance with this feature, it is possible to maintain the resin pressure in close proximity to the target pressure P0 even during the standby step.

The pressure reduction control unit (76) may reduce the resin pressure by performing at least reverse rotation of the screw (28) from among reverse rotation and sucking back of the screw (28), the standby pressure control unit (82) may cause the screw (28) to be rotated based on the predetermined condition, and the predetermined condition may include at least one from among a designation of the upper limit speed indicating the upper limit of the rotational speed of the screw (28), and a designation of the upper limit rotational force indicating the upper limit of the rotational force of the screw (28). In accordance with such features, in the case that the standby pressure control unit (82) causes the screw (28) to be rotated, at least one of the rotational speed and the rotational force of the rotation is prevented from becoming excessive.

The predetermined condition may include the designation of the upper limit speed, and there may further be provided the rotational speed acquisition unit (78) that acquires the rotational speed of the screw (28), and the rotational speed determination unit (84) that determines the upper limit speed on the basis of the maximum value of the rotational speed of the screw (28) acquired while the pressure reduction control unit (76) is causing the screw (28) to be rotated in reverse. In accordance with such features, the standby pressure control unit (82) does not allow the screw (28) to be rotated in excess of the rotational speed at which the screw (28) is rotated during the reduction in pressure. Accordingly, in the case that the standby pressure control unit (82) causes the screw (28) to be rotated, at least one of the rotational speed and the rotational force of the rotation is prevented from becoming excessive.

The predetermined condition may include the designation of the upper limit rotational force, and there may further be provided the rotational force acquisition unit (80) that acquires the rotational force of the screw (28), and the rotational force determination unit (86) that determines the upper limit rotational force on the basis of the maximum value of the rotational force of the screw (28) acquired while the pressure reduction control unit (76) is causing the screw (28) to be rotated in reverse. In accordance with such features, the standby pressure control unit (82) does not allow the screw (28) to be rotated in excess of the rotational force of the screw (28) occurring during the reduction in pressure. Accordingly, in the case that the standby pressure control unit (82) causes the screw (28) to be rotated, at least one of the rotational speed and the rotational force of the rotation is prevented from becoming excessive.

The standby pressure control unit (82) may cause the screw (28) to be rotated based on the predetermined condition, and there may further be provided the operation unit (68) through which the operator designates the predetermined condition.

The predetermined condition may include at least one from among a designation of an upper limit speed indicating an upper limit of a rotational speed of the screw (28), and a designation of an upper limit rotational force indicating an upper limit of a rotational force of the screw (28). In accordance with such features, in the case that the standby pressure control unit (82) causes the screw (28) to be rotated, at least one of the rotational speed and the rotational force of the rotation is prevented from becoming excessive.

There may further be provided the propulsion imparting unit (88) configured to, after the resin pressure has reached the target pressure, maintain the position of the screw (28) in the axial direction by imparting a propulsive force to the screw (28) in a direction opposite to the resin pressure, and the propulsive force acquisition unit (90) that acquires the propulsive force, wherein, after the propulsive force has exceeded the predetermined threshold value, the standby pressure control unit (82) may keep the resin pressure within the predetermined range. In accordance with such features, drooling and the entry of air bubbles (foreign material) into the resin during the standby step are prevented.

There may further be provided the notification unit (94) that issues a notification of the control state of the screw (28) when the standby pressure control unit (82) is causing the screw (28) to be rotated. In accordance with this feature, it becomes easy for the operator to grasp and understand the control state of the screw (28).

### <Second Invention>

In the method of controlling the injection molding machine (10), the injection molding machine including the cylinder (26) into which the resin is supplied, and the screw (28) that moves forward and rearward and rotates inside the cylinder (26), the injection molding machine being configured to perform metering of the resin while the resin is being melted inside the cylinder (26), by causing the screw (28) to be moved rearward to a predetermined metering position while being forwardly rotated, the method includes the pressure reducing step of, after the screw (28) has reached the predetermined metering position, reducing the resin pressure (the pressure of the resin) to a predetermined target pressure, by performing at least one of reverse rotation and sucking back of the screw (28) while acquiring the resin pressure, and the standby pressure control step of, after the pressure reducing step, keeping the resin pressure within a predetermined range by causing the screw (28) to be rotated in a state in which a position of the screw (28) in the axial direction of the cylinder (26) is maintained.

In accordance with such features, the method of controlling the injection molding machine (10) is provided in which the occurrence of molding defects during the standby step are prevented.

What is claimed is:

1. A control device for an injection molding machine, the injection molding machine including a cylinder into which a resin is supplied, and a screw configured to move forward and rearward and rotate inside the cylinder, the injection molding machine being configured to perform metering of the resin while the resin is being melted inside the cylinder, by causing the screw to be moved rearward to a predetermined metering position while being forwardly rotated, the control device comprising:
a pressure acquisition unit configured to acquire a pressure of the resin;
a pressure reduction control unit configured to, after the screw has reached the predetermined metering position, reduce the pressure of the resin to a predetermined target pressure by performing at least one of reverse rotation and sucking back of the screw; and
a standby pressure control unit configured to, after the pressure of the resin has reached the target pressure, keep the pressure of the resin within a predetermined range by causing the screw to be rotated in a state in which a position of the screw in an axial direction of the cylinder is maintained.

2. The control device for the injection molding machine according to claim 1, wherein:
the injection molding machine further comprises a nozzle configured to inject the resin that is melted inside the cylinder; and
the standby pressure control unit keeps the pressure of the resin within the predetermined range, during a period from when the pressure of the resin has reached the target pressure until when the resin is injected from the nozzle.

3. The control device for the injection molding machine according to claim 1, wherein the target pressure is included within the predetermined range.

4. The control device for the injection molding machine according to claim 1, wherein:
the pressure reduction control unit reduces the pressure of the resin by performing at least reverse rotation of the screw, from among reverse rotation and sucking back of the screw;
the standby pressure control unit causes the screw to be rotated based on a predetermined condition; and
the predetermined condition includes at least one from among a designation of an upper limit speed indicating an upper limit of a rotational speed of the screw, and a designation of an upper limit rotational force indicating an upper limit of a rotational force of the screw.

5. The control device for the injection molding machine according to claim 4, wherein:
the predetermined condition includes the designation of the upper limit speed; and
further comprising a rotational speed acquisition unit configured to acquire the rotational speed of the screw, and a rotational speed determination unit configured to determine the upper limit speed based on a maximum value of the rotational speed of the screw acquired while the pressure reduction control unit is causing the screw to be rotated in reverse.

6. The control device for the injection molding machine according to claim 4, wherein:
the predetermined condition includes the designation of the upper limit rotational force; and
further comprising a rotational force acquisition unit configured to acquire the rotational force of the screw, and a rotational force determination unit configured to determine the upper limit rotational force based on a maximum value of the rotational force of the screw acquired while the pressure reduction control unit is causing the screw to be rotated in reverse.

7. The control device for the injection molding machine according to claim 1, wherein:
the standby pressure control unit causes the screw to be rotated based on a predetermined condition; and
further comprising an operation unit through which an operator designates the predetermined condition.

8. The control device for the injection molding machine according to claim 7, wherein the predetermined condition includes at least one from among a designation of an upper limit speed indicating an upper limit of a rotational speed of the screw, and a designation of an upper limit rotational force indicating an upper limit of a rotational force of the screw.

9. The control device for the injection molding machine according to claim 1, further comprising:
a propulsion imparting unit configured to, after the pressure of the resin has reached the target pressure, maintain the position of the screw in the axial direction by imparting a propulsive force to the screw in a direction opposite to the pressure of the resin; and
a propulsive force acquisition unit configured to acquire the propulsive force;
wherein, after the propulsive force has exceeded a predetermined threshold value, the standby pressure control unit keeps the pressure of the resin within the predetermined range.

10. The control device for the injection molding machine according to claim 1, further comprising a notification unit configured to issue a notification of a control state of the screw when the standby pressure control unit is causing the screw to be rotated.

11. A method of controlling an injection molding machine, the injection molding machine including a cylinder into which a resin is supplied, and a screw configured to move forward and rearward and rotate inside the cylinder, the injection molding machine being configured to perform metering of the resin while the resin is being melted inside the cylinder, by causing the screw to be moved rearward to a predetermined metering position while being forwardly rotated, the method comprising:
a pressure reducing step of, after the screw has reached the predetermined metering position, reducing a pressure of the resin to a predetermined target pressure, by performing at least one of reverse rotation and sucking back of the screw while acquiring the pressure of the resin; and
a standby pressure control step of, after the pressure reducing step, keeping the pressure of the resin within a predetermined range by causing the screw to be rotated in a state in which a position of the screw in an axial direction of the cylinder is maintained.
